(19) United States
(12) Patent Application Publication
(10) Pub. No.: US 2006/0158822 A1
(43) Pub. Date: Jul. 20, 2006

(54) Method for attracting glass substrate with electrostatic chuck and electrostatic chuck

(75) Inventors: Shunpei Kondo, Fukuoka (JP); Tetsuo Kitabayashi, Fukuoka (JP)

Correspondence Address: CARRIER BLACKMAN AND ASSOCIATES, 24101 NOVI ROAD, SUITE 100, NOVI, MI, 48375, US

(73) Assignee: TOTO LTD., Fukuoka (JP)

(21) Appl. No.: 11/313,277

(22) Filed: Dec. 20, 2005

(30) Foreign Application Priority Data
Jul. 9, 2003 (JP) 2003-194245

(51) Int. Cl. H01T 23/00

(52) U.S. Cl. 361/234

(57) ABSTRACT

The present invention relates to a method for using an electrostatic chuck which can achieve clamping force of 100 gf/cm² within 60 seconds at low voltage of ±1 kV or less compared to high voltage of the conventional art such as 3 kV or 10 kV for electrostatically clamping a glass substrate. There is provided a method for clamping a glass substrate with an electrostatic chuck having a dielectric layer in which the upper surface of the dielectric layer of the electrostatic chuck has a surface roughness Ra of 0.8 μm or less and the volume resistivity of the dielectric layer of the electrostatic chuck is 10⁸-10¹² Ωcm, comprising the steps of increasing the temperature of the glass substrate so as to change the volume resistivity of the glass substrate to be 10¹⁴ Ωcm or less, and clamping the glass substrate to the upper surface of the dielectric layer of the electrostatic chuck.

### BACKGROUND OF THE INVENTION

1. Field of the Invention

The present invention relates to a processing apparatus for a glass substrate such as a PDP (plasma display panel) manufacturing apparatus, a liquid crystal display manufacturing apparatus, an FED (field emission display) manufacturing apparatus, an organic EL (electroluminescent) manufacturing apparatus, and so on.

2. Description of Prior Art

A glass substrate has been used as a substrate processed in a PDP (plasma display panel) manufacturing apparatus, a liquid crystal display manufacturing apparatus, an FED (field emission display) manufacturing apparatus, and an organic EL (electroluminescent) manufacturing apparatus.

These days, in the above-mentioned manufacturing apparatus, manufacturing processes have been changed as products become highly precise, displays become large, and the size of mother glass substrates is increased. In the manufacturing processes, a vacuum process is partly introduced, and an electrostatic chuck is used for fixing and retaining a glass substrate within a vacuum.

There are cases where a conductive film such as an electric circuit is formed on a glass substrate in advance. If a conductive film is formed on a glass substrate, the electrostatic chuck and the conductive film draw each other with electrostatic force, so that electrostatic clamping can be achieved.

If a conductive film is not formed on a glass substrate, electrostatic clamping force is obtained by coating a conductive film such as ITO on a surface of the glass substrate to come into contact with the electrostatic chuck (Patent Document 1).

Soda-lime glass can be clamped by applying voltage of ±3 kV in an electrostatic clamping apparatus (Patent Document 2).

An electrostatic chuck has been disclosed in which electrodes are alternately provided at a small interval so as to electrostatically clamp glass on which no conductive film is formed (Patent Document 3).

Patent Document 1: Japanese Patent Application Publication 11-163110

Patent Document 2: Japanese Patent Application Publication 2002-280438

Patent Document 3: Japanese Patent Application Publication 2000-332091

In the conventional method of using an electrostatic chuck, electrostatic clamping force is achieved by allowing the conductive film formed on the glass substrate and the electrostatic chuck to draw each other with electrostatic force. However, there is a drawback that the electrostatic clamping force is deteriorated depending on the area of the glass substrate where the conductive film is formed and the pattern of forming the conductive film.

Also, a conductive film is coated so as to obtain electrostatic clamping force in the method shown in Patent Document 1. However, according to this method, the cost will be increased.

There is a description of electrostatic clamping force in a case where a substrate to be processed is soda-lime glass in Patent Document 2. However, soda-lime glass is not a suitable glass to be processed in a PDP (plasma display panel) manufacturing apparatus, a liquid crystal display manufacturing apparatus, an FED (field emission display) manufacturing apparatus, an organic EL (electroluminescent) manufacturing apparatus, or the like because soda-lime glass contains a lot of alkali ingredients and the temperature where viscous flow occurs is low. Instead, high strain point glass or non-alkali glass is used in the above-mentioned apparatus. However, since high strain point glass and non-alkali glass has large resistivity compared to soda-lime glass, it is impossible to obtain clamping force by the method shown in Patent Document 2.

According to the electrostatic chuck disclosed in Patent Document 3, it is possible to electrostatically clamp glass on which no conductive film is formed. However, since the voltage required for clamping is 10 kV, there are drawbacks such as insulation processing to wiring for the power supply for clamping, dielectric breakdown of the electrostatic chuck, or high cost of the power supply for clamping.

The present invention was made to solve the above-mentioned drawbacks, and the object of the present invention is to provide a method for using an electrostatic chuck which makes it possible to electrostatically clamp a glass substrate on which no conductive film is formed at sufficiently low voltage of ±1 kV or less compared to high voltage of the conventional art.

### SUMMARY OF THE INVENTION

In order to achieve the above-mentioned object, according to the present invention, there is provided a method for clamping a glass substrate with an electrostatic chuck having a dielectric layer in which the upper surface of the dielectric layer of the electrostatic chuck has a surface roughness Ra of 0.8 μm or less and the volume resistivity of the dielectric layer of the electrostatic chuck is 10⁸- 10¹² Ωcm, comprising the steps of increasing the temperature of the glass substrate so as to change the volume resistivity of the glass substrate to be 10¹⁴ Ωcm or less, and clamping the glass substrate to the upper surface of the dielectric layer of the electrostatic chuck.

When these conditions are satisfied, the Johnsen-Rahbeck effect appears in the contact boundary between the glass substrate and the electrostatic chuck, and electrostatic clamping can be performed at low voltage of ±1 kV or less.

The volume resistivity of glass decreases at an exponential rate as the temperature of the glass increases. According to the present invention, the Johnsen-Rahbeck effect appears on a practical level by electric current flowing through the contact boundary between the glass substrate serving as a material to be clamped and the electrostatic chuck at the temperature where the volume resistivity of glass is 10¹⁴ Ωcm or less, and thereby the glass substrate can be electrostatically clamped.

A preferred embodiment of the present invention is characterized in that the material to be clamped is high strain point glass, and the temperature of the glass substrate is 120-350 degrees.

The volume resistivity of the high strain point glass serving as a glass substrate to be electrostatically clamped is about 10¹⁴ Ωcm at 120° C., and the glass substrate can be electrostatically clamped by the Johnsen-Rahbeck effect.

A preferred embodiment of the present invention is characterized in that a heater is incorporated into the electrostatic chuck.

The electrostatic chuck of the present invention can generate electrostatic clamping force more quickly as the temperature of the glass substrate increases. Thus, it is preferable that the electrostatic chuck is provided with a function of heating a glass substrate and maintaining the temperature of the heated glass substrate.

A preferred embodiment of the present invention is characterized in that a backing plate having heating function is attached to the electrostatic chuck.

The electrostatic chuck of the present invention can generate electrostatic clamping force more quickly as the temperature of the glass substrate increases. Thus, it is preferable that the electrostatic chuck is provided with a function of heating a glass substrate and maintaining the temperature of the heated glass substrate.

According to the present invention, there is also provided an electrostatic chuck comprising a dielectric layer in which a glass substrate is clamped to the upper surface of the dielectric layer, wherein the upper surface of the dielectric layer of the electrostatic chuck has a surface roughness Ra of 0.8 μm or less, the volume resistivity of the dielectric layer of the electrostatic chuck is 10⁸-10¹² Ωcm at the time of clamping the glass substrate, and the volume resistivity of the glass substrate is changed to be 10¹⁴ Ωcm or less by heating the glass substrate so as to electrostatically clamp the glass substrate, wherein the electrostatic chuck further comprises a temperature measuring means.

By detecting and controlling the temperature of the electrostatic chuck, it is possible to provide an electrostatic chuck in which the temperature of the glass substrate can be controlled more precisely.

### BRIEF DESCRIPTION OF THE DRAWINGS

FIG. 1 is a cross-sectional view showing an example of a method for using an electrostatic chuck according to the present invention.

### DETAILED DESCRIPTION OF PREFERRED EMBODIMENTS

Table 1 shows properties of an electrostatic chuck and electrostatically clamping force when volume resistivity of a glass substrate is changed.

TABLE 1

| | | | | | | clamping force after |
|---|---|---|---|---|---|---|
| | Scope of | volume resistivity | surface roughness | | | voltage of ± 1 kV is |
| | present | of electrostatic | of electrostatic | volume resistivity | Temperature | applied for 60 |
| No. | invention | chuck (Ω cm) | chuck (μm) | of glass (Ω cm) | (° C.) | seconds (gf/cm²) |
| 1 | O | 10^{8.5} | 0.2 | 10¹² | 170 | 2000 |
| 2 | O | 10^{8.5} | 0.8 | 10¹² | 170 | 130 |
| 3 | X | 10^{8.5} | 2 | 10¹² | 170 | 10 |
| 4 | O | 10^{8.0} | 0.2 | 10⁸ | 350 | 3000 |
| 5 | O | 10^{9.2} | 0.2 | 10¹⁰ | 250 | 3000 |
| 6 | O | 10^{9.3} | 0.2 | 10¹⁴ | 120 | 280 |
| 7 | X | 10^{9.9} | 0.2 | 10¹⁵ | 90 | 12 |
| 8 | X | 10^{10.4} | 0.2 | 10¹⁶ | 70 | 1 or less |
| 9 | O | 10^{10.2} | 0.2 | 10¹² | 170 | 2000 |
| 10 | O | 10^{12.0} | 0.2 | 10¹⁴ | 120 | 170 |
| 11 | X | 10^{12.6} | 0.2 | 10¹⁴ | 120 | 56 |

As for the material of the electrostatic chuck used in the tests shown in Table 1, the main ingredient was alumina, and kaoline was added to the main ingredient as a sintering aid. The volume resistivity of the material of the electrostatic chuck was changed by adding an appropriate amount of chromia and titania. The material was formed into a sheet shape, clamping electrodes were provided in a predetermined position, and thereafter it was laminated and fired so as to manufacture an electrostatic chuck. The thickness of the dielectric layer of the electrostatic chuck was 500-800 μm. The clamping electrodes of the electrostatic chuck were provided alternately to be bipolar with the electrode width of 1- 2 mm and the electrode distance of 1-2 mm. The temperature of the electrostatic chuck was measured by a K thermocouple fixed on a surface of the electostatic chuck.

As for the volume resistivity of the material of the dielectric layer of the electrostatic chuck, the volume resistivity of a sample made of the same material as the electrostatic chuck was measured by a method described in JIS C 2141, and the measuring results were used.

Incidentally, the volume resistivity of the electrostatic chuck in Table 1 is the volume resistivity at the temperature where the tests were performed.

High strain point glass was used for a glass substrate as a material to be clamped. The diameter was 12-40 mm, and the thickness was 2.8 mm. No conductive film was formed on the glass as a material to be clamped. The temperature of the glass was measured by a K thermocouple fixed on a non-clamped surface of the glass. The volume resistivity of the glass was measured by a method described in JIS C 2141.

In order to measure the clamping force, the glass was electrostatically clamped in vacuum and lifted up vertically, and the force where the glass was released was measured.

Preferably, the clamping force is 60 gf/cm² or more so as to electrostatically clamp a glass substrate with an electrostatic chuck, and such clamping force is achieved within 60 seconds. Exhausting is performed in a common vacuum processing chamber after a substrate is inserted, and the time required for exhausting is around several minutes. In a case of performing electrostatic clamping during exhausting, if the required clamping force is achieved within 60 seconds, it is enough for an actual use. Although the required clamping force depends on the process, 60 gf/cm² or more is preferable because common gas pressure in a case where the temperature of the glass substrate is controlled by adjusting the gas pressure filled between the glass substrate and the electrostatic chuck is at most around 50 gf/cm². More preferably, it is 100 gf/cm² or more because the safety factor is double.

No. 1, No. 2, and No. 3 show the results of the clamping force when the glass was heated to around 170° C. and the surface roughness of the electrostatic chuck was changed.

The clamping force of the present invention is caused by the Johnsen-Rahbeck effect, and the surface roughness of the contact boundary between a material to be clamped and an electrostatic chuck affects the electrostatic clamping force. Since the surface roughness Ra of glass is 0.05 μm or less which is sufficiently smooth compared to the electrostatic chuck, the clamping force is affected by the surface roughness of the electrostatic chuck. The results of the present tests show that the surface roughness of the electrostatic chuck needs to be 0.8 μm or less and preferably 0.2 μm.

No. 1, No. 4, No. 5, No. 6, No. 7 and No. 8 shows the results of the measurements when the glass was heated to around 170° C., around 350° C., around 250° C., around 120° C., around 90° C., and around 70° C., respectively, and the volume resistivity of the glass was changed.

Regarding No. 4 and No. 5, the electrostatic clamping force was the same, while the volume resistivity of the glass was different. It is well known that the clamping force caused by the Johnsen-Rahbeck effect depends on the time of applying voltage, and the clamping force saturates to a constant value after voltage is applied for a certain period of time. The results of the present tests show that the clamping force reached a saturation value within 60 seconds in the test conditions of No. 4 and No. 5. No. 1, No. 6, No. 7 and No. 8 show that the clamping force caused by the Johnsen-Rahbeck effect was deteriorated because the response time of the clamping force became long as the volume resistivity of the glass increased. According to the results of the present tests, the electrostatic clamping force due to the Johnsen-Rahbeck effect is generated effectively when the volume resistivity of the glass is 10¹⁴ Ωcm or less, and the electrostatic clamping force saturates within 60 seconds when the volume resistivity of the glass is 10¹⁰ Ωcm or less.

No. 1 and No. 9 show the results of tests where the electrostatic clamping force was measured when the volume resistivity of the dielectric material of the electrostatic chuck was changed and the temperature of the glass was kept around 170° C. There is no difference in the electrostatic clamping force between No. 1 and No. 9. No. 6, No. 10 and No. 11 show the results of tests where the electrostatic clamping force was measured when the volume resistivity of the dielectric material of the electrostatic chuck was changed and the temperature of the glass was kept around 120° C. The clamping force was deteriorated as the volume resistivity of the dielectric material of the electrostatic chuck increased. According to the results of the present tests, it is shown that the volume resistivity of the glass determined the response time of the clamping force because the volume resistivity of the dielectric material of the electrostatic chuck was sufficiently low in No. 1 and No. 9. It is also shown that both the volume resistivity of the dielectric material of the electrostatic chuck and the volume resistivity of the glass determined the response time of the clamping force in No. 6, No. 10, and No. 1 1. According to the results of the present tests, it turned out that the volume resistivity of the dielectric material of the electrostatic chuck is preferable to be 10¹² Ωcm or less at the temperature where it is used.

Larger electric current flows at the time of applying voltage as the volume resistivity of the electrostatic chuck decreases. Large electric current requires an expensive clamping power supply. Thus, the volume resistivity of the electrostatic chuck needs to be a reasonably great value. Generally, the preferable volume resistivity of the electrostatic chuck is 10⁸ Ωcm or more at the temperature where it is used, although it depends on the size of the electrostatic chuck, the arrangement pattern of the clamping electrodes, and the material to be clamped.

The temperature is preferably within a range which allows the volume resistivity of the glass to be 10¹⁴ Ωcm or less. According to Table 1, the more preferable range is 120-350 degrees.

Also, when the applied voltage was decreased to be ±200V with the volume resistivity of the electrostatic chuck, the volume resistivity of the glass, and the temperature being the same as No. 1, the clamping force after 60 seconds was 100 gf/cm². Therefore, if the clamping force is great, it is preferable to adjust the clamping force to be reasonable by decreasing the applied voltage.

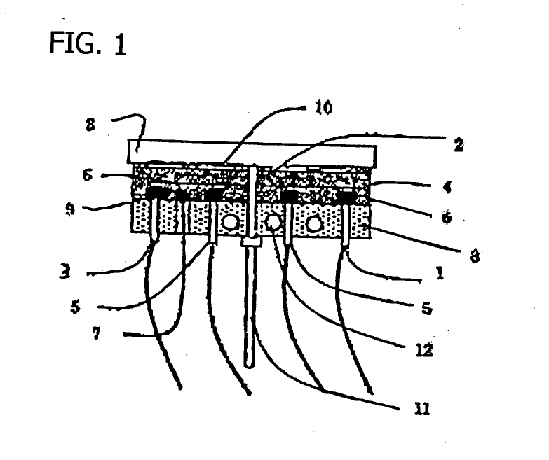

Hereinafter, embodiments according to the present invention will be explained with reference to the attached drawings. FIG. 1 is a cross-sectional view showing a state where a glass substrate is electrostatically clamped by using an electrostatic chuck while the glass substrate is processed in vacuum.

In FIG. 1, voltage is applied to a clamping electrode 2 through a conductor 1 for applying clamping voltage, and electrostatic force is generated between a glass substrate 3 and an electrostatic chuck 4.

A heater electrode 6 generates heat by electric power supplied from a conductor 5 for the heater electrode.

The temperature of the electrostatic chuck 4 is measured by a temperature sensor 7 such as a thermocouple. The temperature of the glass substrate 3 and the electrostatic chuck 4 is controlled by adjusting electric power supplied to the conductor 5 for the heater electrode. Incidentally, the temperature sensor may be a non-contact type such as a radiation thermometer.

In FIG. 1, a backing plate 8 is attached to the electrostatic chuck 4 with an attaching portion 9. A preferable example of an attaching method includes brazing, a heat-resistant adhesive, bolting, or the like. It is also possible to incorporate a heater into the backing plate.

In FIG. 1, a recessed portion 10 is provided in the contact boundary between the glass substrate 3 and the electrostatic chuck 4. Gas supplied from a gas introducing tube 11 is filled into the recessed portion 10. By controlling the pressure of the filled gas with a pressure controller (not shown in the drawings), it is possible to control the heat transfer of the contact boundary between the glass substrate 3 and the electrostatic chuck 4 so as to control the temperature of the glass substrate 3. If the pressure of air on the side which is not in contact with the electrostatic chuck is several tens of Torr or more, the difference of the pressure is caused by reducing the pressure of the recessed portion 10 and the gas introducing tube 11 with the pressure controller, so that the electrostatic chuck can be used as a vacuum chuck.

In FIG. 1, a medium passage 12 is provided, and the temperature of the backing plate 8 can be controlled by changing the temperature, the flow rate, and the material of the medium.

According to the present invention, with the above-mentioned structure and the using method, it is possible to provide a method for clamping a glass substrate and an electrostatic chuck in which a glass substrate having no conductive film can be electrostatically clamped at voltage of ±1 kV or less.

1. A method for clamping a glass substrate with an electrostatic chuck having a dielectric layer in which the upper surface of the dielectric layer of the electrostatic chuck has a surface roughness Ra of 0.8 μm or less and the volume resistivity of the dielectric layer of the electrostatic chuck is 10⁸-10¹² Ωcm, comprising the steps of:
increasing the temperature of the glass substrate so as to change the volume resistivity of the glass substrate to be 10¹⁴ Ωm or less; and
clamping the glass substrate to the upper surface of the dielectric layer of the electrostatic chuck.

2. The method for clamping a glass substrate with an electrostatic chuck according to claim 1, wherein the glass substrate is made of high strain point glass, and the temperature of the glass substrate is 120-350 degrees.

3. The method for clamping a glass substrate with an electrostatic chuck according to claim 1, wherein a heater electrode is incorporated into the electrostatic chuck.

4. The method for clamping a glass substrate with an electrostatic chuck according to claim 1, wherein a backing plate having a heating function is attached to the electrostatic chuck.

5. An electrostatic chuck comprising a dielectric layer in which a glass substrate is clamped to the upper surface of the dielectric layer, wherein the upper surface of the dielectric layer of the electrostatic chuck has a surface roughness Ra of 0.8 μm or less, the volume resistivity of the dielectric layer of the electrostatic chuck is 10⁸-10¹² Ωcm, and the volume resistivity of the glass substrate is changed to be 10¹⁴ Ωcm or less by beating the glass substrate so as to electrostatically clamp the glass substrate, wherein the electrostatic chuck further comprises a temperature measuring means.

6. The method for clamping a glass substrate with an electrostatic chuck according to claim 2, wherein a heater electrode is incorporated into the electrostatic chuck.

7. The method for clamping a glass substrate with an electrostatic chuck according to claim 2, wherein a backing plate having a heating function is attached to the electrostatic chuck.
